(19) United States
(12) Patent Application Publication
(10) Pub. No.: US 2023/0237895 A1
(43) Pub. Date: Jul. 27, 2023

(54) Radio Tracking System for Personal Belongings

(71) Applicant: Bob Stout, Peoria, AZ (US)

(72) Inventor: Bob Stout, Peoria, AZ (US)

(21) Appl. No.: 18/160,362

(22) Filed: Jan. 27, 2023

Related U.S. Application Data
(60) Provisional application No. 63/303,525, filed on Jan. 27, 2022.

(51) Int. Cl. G08B 21/24; G08B 7/06; G06K 19/07; H04W 4/029; H04W 4/80; G06F 1/16

(52) U.S. Cl. CPC G08B 21/24; G08B 7/06; G06K 19/0723; H04W 4/029; H04W 4/80; G06F 1/163

(57) ABSTRACT

The present invention relates generally to the field of tracking systems. More specifically, the present invention relates to a radio tracking system that is primarily comprised of at least one tracking tag, further comprised of at least one transmitter, at least one color indicator, and at least one wristband, further comprised of at least one LED and at least one motor. The tracking tag is preferably of discrete shape and size and may be fixedly or removably attached to any item that may be lost or misplaced. The wristband is comprised of a flexible or semi flexible material that features at least one fastener and receives signals that are sent from the internal transmitter of the tracing tag. LED lights illuminate to the corresponding color indicated on the tracking tag. In this manner, the system allows for efficient and quick location of lost or misplaced items.

### CROSS-REFERENCE TO RELATED APPLICATION

The present application claims priority to, and the benefit of, U.S. Provisional Application No. 63/303,525, which was filed on Jan. 27, 2022, and is incorporated herein by reference in its entirety.

### FIELD OF THE INVENTION

The present invention relates generally to the field of tracking devices. More specifically, the present invention relates to a tracking system that is comprised of a compact tracking tag, and a discrete wristband that can communicate in any electrical communication method via an internal transmitter, but preferably via radio frequency. The tracking tag preferably resembles a dollar coin shape, is thin enough to placed inside of a wallet, is labeled with a uniquely assigned color, and may be attachable via a variety of mechanisms to any item, such as a set of keys. The wristband may be comprised a flexible or semi flexible material that may slip over the hand of the user or be fastened with at least one fastening mechanism. Additionally, the wristband may be further comprised of a body that contains at least one rechargeable battery, and LED lights that may illuminate at the moment a corresponding-colored tracking tag is lost and/or found. In this manner, the system can be applied to any item that a user may frequently lose or misplace and allow them to locate it swiftly and efficiently without the need for a smart device. Accordingly, the present disclosure makes specific reference thereto. Nonetheless, it is to be appreciated that aspects of the present invention are also equally applicable to other like applications, devices, and methods of manufacture.

### BACKGROUND

Many individuals lose items such as keys, wallets, purses, etc., on a daily basis. This is undesirable, as an individual then may need to spend a significant amount of a time searching for the lost item. This process can become incredibly annoying and frustrating, especially if an individual regularly loses items. Further, existing attachable tracking devices known in the art typically require a smart device, such as a smart phone application, to be used in conjunction with the tracking device. This is problematic for individuals who do not use a smart device. Considerably, many of those from older generations do not use smart devices, and coincidentally are more likely to lose or leave items where they may not remember.

Therefore, there exists a long-felt need in the art for a radio tracking system for personal belongings. There also exists a long-felt need in the art for a radio tracking system for personal belongings that allows a user to easily find lost items. Finally, there exists a long-felt need in the art for a system that does not require a smart device and a smart phone application to be used.

The subject matter disclosed and claimed herein, in one embodiment thereof, comprises a radio tracking system for personal belongings. The system is primarily comprised of at least one tracking tag, further comprised of at least one transmitter, at least one color indicator, and at least one wristband, further comprised of at least one LED and at least one motor. The tracking tag communicates via the transmitter to a wristband. The wristband receives the signal of the tag and illuminates at least one LED light that corresponds to the tracking tag's color indicator to alert a user when they are leaving behind an item with an attaching tracking tag.

In this manner, the radio tracking system for personal belongings of the present invention accomplishes all of the foregoing objectives and provides an improved means to find and locate lost or misplaced items. Further, the system is not bound to a fixed object or item, and instead may be removed and reassigned to a different item at the user's preference. Additionally, the system utilizes color indicators such that, multiple tags may be used simultaneously, wherein the user may clearly and definitively determine which tag is sending a signal that it is lost and/or found. Finally, the system does not require the use of any smart device.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a radio tracking system for personal belongings. The system is primarily comprised of at least one tracking tag, further comprised of at least one transmitter, at least one color indicator, and at least one wristband, further comprised of at least one LED and at least one motor. In differing embodiments, the tracking tag of the device may have the appearance of a plurality of different shapes and colors. However, in the preferred embodiment, the tracking tag device resembles a circular, relatively thin coin-like shape, such that it is small enough to fit inside of a wallet and may contain an eyelet to be attached to a pair of keys. The tracking device communicates with a wristband worn by the user via any electronic communication system, but preferably utilizes radio frequency such that, the user need not have a smart device to use the system. The wristband worn by the user is further comprised of a strap, which may feature any flexible or semi flexible material so that it may be slipped over the hand of the user or may fastened to the wrist of the user via any fastening mechanism known in the art, including, but not limited to, magnetic, hook and loop, buckle, and adhesive, etc. The wrist strap may have at least one fastening mechanism. Additionally, the body of the wristband and any surface of the tracking tag may be comprised of a plurality of indicia such as patterns, logos, emblems, images, symbols, designs, letters, words, characters, animals, advertisements, brands, etc., that may or may not be radio tracking related.

The body of the wrist strap also may be fixedly or removably attached to the strap, and is capable of receiving electrical communication signals, including, but not limited to, Wi-Fi, Bluetooth, data roaming, radio, etc. The body also features at least one rechargeable battery, and LED lights that may illuminate at the reception of a signal of the tracking device to indicate to the user that the color corresponding tracking tag has been lost and/or found. The LED lights are further powered by a motor that vibrates and allows for continuous and instantaneous illumination upon reception of a signal from a transmitter.

Accordingly, the radio tracking system for personal belongings of the present invention is particularly advantageous as it allows a user to locate their lost or misplaced item quickly and efficiently. Further, the tracking tag of the system is attachable to any number of items, including, but not limited to, a backpack, keys, wallet, etc. Additionally, the system does not require the use of a smart device as it can communicate via radio frequency. In this manner, the radio tracking system for personal belongings overcomes the limitations of existing tracking devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a tracking tag of one potential embodiment of a radio tracking system for personal belongings of the present invention in accordance with the disclosed architecture;

FIG. 2 illustrates a perspective view of a wristband of one potential embodiment of a radio tracking system for personal belongings of the present invention in accordance with the disclosed architecture; and

FIG. 3 illustrates a perspective view of one potential embodiment of a radio tracking system for personal belongings of the present invention while attached to a key ring and keys (shown as prior art) in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved personal belonging tracking system. There also exists a long-felt need in the art for a radio tracking system for personal item use that allows a user to locate their items when they are lost. Furthermore, there exists a long-felt need in the art for a radio tracking system device that does not require the use of a smart device, and can thus be accessible to a wide range of populations, namely the elderly, which are less likely to use smart devices themselves and are more likely to lose or misplace items.

The present invention is comprised of a radio tracking system for personal belongings. The system is comprised of at least one tag and at least one wristband. However, in the preferred embodiment, the system is comprised of a plurality of color-coded tags. Each tag is preferably comprised of a clip, key ring or adhesive surface that allows the tag to be removably attached to an item such as, but not limited to, keys, wallets, purses, etc. Each tag is further in electrical communication with the wristband via a radiofrequency or other similar connection method of the like (e.g., near field communications, etc.). The wristband is further comprised of a plurality of lights, wherein each light is colored to correspond with the color of each tag. In this manner, when the wristband travels a specified distance away from a tag, the color of the tag will flash on the wristband to alert the user of the same. The wristband can also be configured to beep or vibrate to alert the user. Further, the wristband is preferably powered by a replaceable battery. In this manner, the wristband alerts a user when he or she is traveling away from an item to which the tag is attached. Exact specifications may vary upon further development.

Accordingly, the radio tracking system device of the present invention is particularly advantageous as it allows a user to find their lost or misplaced items. Further, the device allows the user to locate their lost or misplaced items without a smart device, increasing access to populations, namely the elderly, who may not have smart devices. Therefore, the device diminishes the time and energy wasted on looking for an item that has been misplaced and ensures quick and simple location.

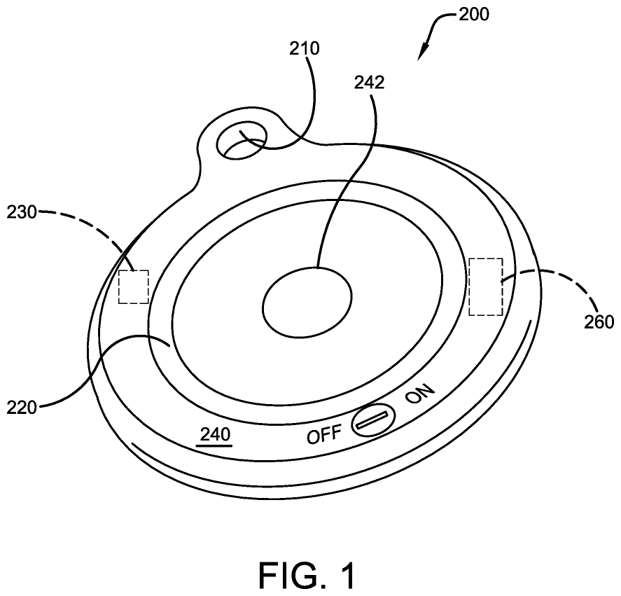

Referring initially to the drawings, FIG. 1 illustrates a perspective view of a tracking tag 200 of one potential embodiment of a radio tracking system 100 for personal belongings of the present invention in accordance with the disclosed architecture. The system 100 is primarily comprised of at least one tracking tag 200, further comprised of at least one transmitter 230 and at least one color indicator 220, and well as at least one battery 260. The transmitter 230 may place the tracking tag 200 in electrical communication via a variety of electrical communication methods, including, but not limited to, Wi-Fi, Bluetooth, data roaming, NFC, radio, sonar, etc., with the wristband 300. However, in the preferred embodiment, radio frequency is the preferred method of communication used by the system 100. In differing embodiments, the tracking tag 200 of the system 100 may be made of a plurality of materials including, but not limited to, semi flexible or inflexible plastic, such as, but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc. In addition, the color indicator 220 may be any color, including, but not limited to, red, orange, yellow, green, blue, indigo, violet, pink, gray, black, white, magenta, neon, etc., and may be placed on at least one surface of the system 100. Further, the top surface 240 of the tag 200 may be comprised of at least one fastener 242. The fastener 242 may be, but is not limited to, adhesive, hook and loop, magnetic, or any other such attachment mechanism known in the art. Additionally, the tracking tag 200 may attach to a key ring 10 via an eyelet 210 allowing for the safe and secure transport of the tag 200 on a set of keys 12. The key ring 10 may be fixedly or removably attached and may rotate up to 360 degrees or remain fastened in place. The battery 260 of the system 100 may feature any battery pack conventionally used for smaller use items such as watches, including, but not limited to, AG13, SG13, LR1154, SR44, SR44SW, or any other such button/coin battery.

In the preferred embodiment of the system 100 shown in FIGS. 1, 2, and 3, the shape of the tracking tag 200 of the system 100 is preferably circular and thin enough to fit in a conventionally sized wallet, however, according to user preference, in differing embodiments, may be of any such shape including, but not limited to, a rectangle, square, oval, triangle, etc.

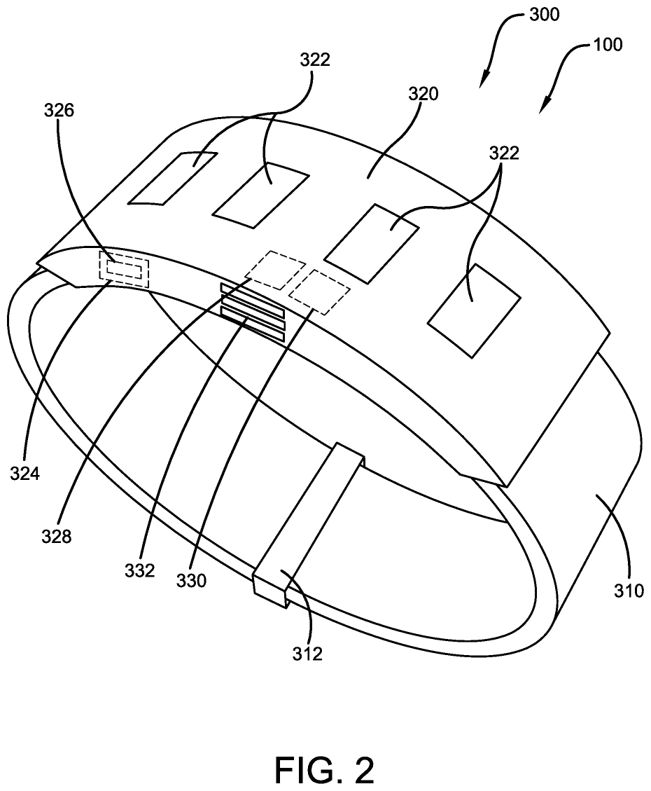

FIG. 2 illustrates a perspective view of a wristband 300 of one potential embodiment of a radio tracking system 100 for personal belongings of the present invention in accordance with the disclosed architecture. The wristband 300 is primarily comprised of a body 320, strap 310, LEDs 322, and a fastener 312. The body 320 is further comprised of a battery 324 that may power the wristband 300. The wristband 300 receives signals from the tracking tags 200 via at least one receiver 330.

In one embodiment, the wristband 300 receives a signal from a tracking tag 200, wherein the respective LED 322 (that corresponds to that specific tracking tag 200) will illuminate thereby indicating which of the tracking tags 200 is nearby. In a differing embodiment, the tracking tag 200 is continuously transmitting a signal to the wristband 300, wherein the respective LED 322 (that corresponds to that specific tracking tag 200) will illuminate when the tag 200 is out of range (i.e., stops wireless communication) with the wristband 300. In this manner, the system 100 alerts a user that they have left an item behind.

In either embodiment, the speaker 332 may play a sound to the user also indicating that an item is nearby or is out of range (i.e., has been left behind or lost). The body 320 of the wristband 300 may feature at least one LED 322, powered by at least one battery 324. In differing embodiments, any number of LEDs 322 may be any number of different colors to correspond with any number of different tracking tags 200. The battery 324 may be recharged via at least one charging port 326 that may be any battery port 324 known in the art, including, but not limited to, a USB port. In one embodiment, the wristband 300 has at least one motor 328 that vibrates upon signal reception or signal loss to further alert a user that a tag 200 is nearby or is out or range.

The strap 310 may be a continuous flexible material such as rubber or elastic that may be comprised of at least one fastener 312, or an inflexible material such as a rigid plastic or metal band requiring the use of a fastener 312. The fastener 312 may ,utilize any such attachment mechanism known in the art, including, but not limited to, buckle and hole, adhesive, magnetic, hook and loop, etc.

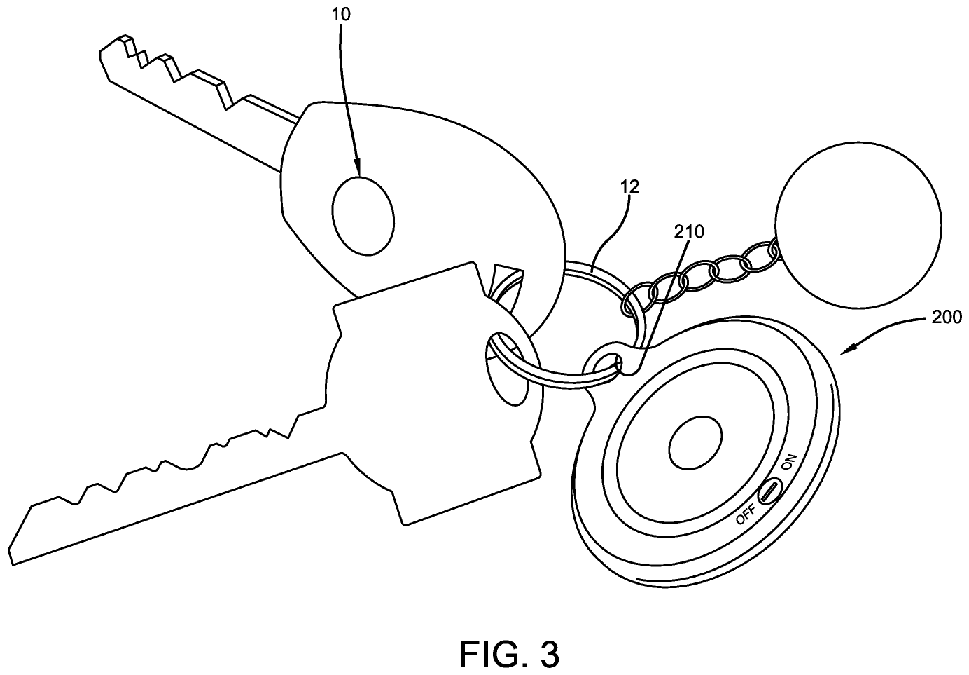

FIG. 3. Illustrates a perspective view of a set of keys 12 with a tracking tag 200 attached to a key ring 10. The tracking tag 200 is secured to the key ring via the eyelet 210. In this manner, the tag 200 can be easily and discreetly attached to commonly lost objects such as, but not limited to, keys.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “radio tracking system for personal belongings” and “system” are interchangeable and refer to the radio tracking system for personal belongings 100 of the present invention.

Notwithstanding the foregoing, the radio tracking system for personal belongings 100 of the present invention and its various components can be of any suitable size and configuration as is known in the art without affecting the overall concept of the invention, provided that they accomplish the above-stated objectives. One of ordinary skill in the art will appreciate that the size, configuration, and material of the radio tracking system for personal belongings 100 as shown in the FIGS. are for illustrative purposes only, and that many other sizes and shapes of the radio tracking system for personal belongings 100 are well within the scope of the present disclosure. Although the dimensions of the radio tracking system for personal belongings 100 are important design parameters for user convenience, the radio tracking system for personal belongings 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Claims what is claimed is:

1. A radio tracking system for a personal belonging, the radio tracking system comprising:
a tracking tag comprised of a transmitter and a battery; and
a wristband comprised of an LED, a battery, a receiver and a motor.

2. The radio tracking system for a personal belonging of claim 1, wherein the transmitter of the tracking tag is in wireless electrical communication with the receiver of the wristband.

3. The radio tracking system for a personal belonging of claim 2, wherein the wireless electrical communication is a radio frequency.

4. A radio tracking system for a personal belonging, the radio tracking system comprising:
a tracking tag comprised of a transmitter, a button and a battery; and
a wristband further comprised of an LED, a battery, a receiver, and a motor.

5. The radio tracking system for a personal belonging of claim 4, wherein the transmitter of the tracking tag is in wireless electrical communication with the receiver of the wristband.

6. The radio tracking system for a personal belonging of claim 5, wherein the wireless electrical communication is a Bluetooth communication.

7. The radio tracking system for a personal belonging of claim 4, wherein the LED illuminates when a signal of the transmitter is received by the receiver.

8. The radio tracking system for a personal belonging of claim 4, wherein the motor vibrates when a signal of the transmitter is received by the receiver.

9. A radio tracking system for a personal belonging, the radio tracking system comprising:
a tracking tag comprised of a transmitter, a button, a color indicator and a battery; and
a wristband comprised of a strap, a speaker, an LED, a battery, a receiver and a motor.

10. The radio tracking system for a personal belonging of claim 9, wherein the transmitter of the tracking tag is in wireless electrical communication with the receiver of the wristband.

11. The radio tracking system for a personal belonging of claim 10, wherein the wireless electrical communication is a radio frequency.

12. The radio tracking system for a personal belonging of claim 9, wherein the LED illuminates when a signal of the transmitter is lost by the receiver.

13. The radio tracking system for a personal belonging of claim 9, wherein the motor vibrates when a signal of the transmitter is lost by the receiver.

14. The radio tracking system for a personal belonging of claim 9, wherein the speaker produces a sound when a signal of the transmitter is lost by the receiver.

15. The radio tracking system for a personal belonging of claim 9, wherein the tracking tag further comprises an eyelet.

16. The radio tracking system for a personal belonging of claim 9, wherein the LED of the wristband illuminates a same color as the color indicator.

17. The radio tracking system for a personal belonging of claim 9, wherein the strap of the wristband is further comprised of a fastener.

18. The radio tracking system for a personal belonging of claim 17, wherein the fastener is a buckle and hole fastener.

19. The radio tracking system for a personal belonging of claim 9, wherein the tracking tag is further comprised of a fastener.

20. The radio tracking system for a personal belonging of claim 19, wherein the fastener is a hook and loop fastener or a magnetic fastener.
